(19) United States
(12) Patent Application Publication
(10) Pub. No.: US 2008/0140988 A1
(43) Pub. Date: Jun. 12, 2008

(54) METHOD AND DEVICE FOR REDUCING MEMORY RESOURCE UTILIZATION

(75) Inventors: Chien-Ju Li, Pingtung County (TW); Oscal Tzyh Chiang Chen, Chiayi County (TW); Guo-Zua Wu, Taichung City (TW)

Correspondence Address: QUINTERO LAW OFFICE, PC, 2210 MAIN STREET, SUITE 200, SANTA MONICA, CA, 90405, US

(73) Assignee: INDUSTRIAL TECHNOLOGY RESEARCH INSTITUTE, HSINCHU (TW)

(21) Appl. No.: 11/852,211

(22) Filed: Sep. 7, 2007

(30) Foreign Application Priority Data
Dec. 8, 2006 (TW) TW95145936

(51) Int. Cl. G06F 12/04

(52) U.S. Cl. 711/211; 711/212; 711/E12.015

(57) ABSTRACT

A method for reducing memory resource utilization is disclosed, applied to simplify address space of a table. Values stored in address fields of an original table are analyzed to determine whether logical relationship is detected between the values. If the logical relationship is detected, the values stored in the original table are classified to multiple base values and corresponding reduced values to generate a transformation table. Values with the same logical relationship for base values and the corresponding reduced values are stored in a new and equivalent address field of a reduction table.

### BACKGROUND OF THE INVENTION

1. Field of the Invention

The invention relates to a method and device for reducing memory resource utilization, and more particularly to a method and device for reducing memory resource utilization during video or audio processes.

2. Description of the Related Art

With respect to dynamic data compression, a memory can be divided to multiple 16×16 blocks, referred to as macroblocks. Each macroblock can be divided into 4 blocks, each serving as a basic unit for compression.

A discrete cosine transform (DCT) can be implemented on 8×8 blocks for better energy concentration. Next, the 8×8 blocks are quantized to generate lossy compression and a variable length coding (VLC) is implemented on the resulting compressed blocks for transmission to an output terminal. Further, for better encoding efficiency, direct coefficient/alternating coefficient (DC/AC) prediction are implemented on the 8×8 blocks after being quantized to generate smaller difference values and run length coding (RLC) is then implemented thereon.

Thus, inverse quantization is not immediately implemented on coefficients generated by processes variable length decoding (VLD) at a decoding terminal but prediction and compensation of difference are first implemented on direct coefficients and alternating coefficients. If current block and prediction block with different quantization parameters, coefficient scaling must be implemented to achieve the same level.

With respect to Microsoft Video Codec 1 (VC-1), a lookup table utilizing multiplying and shifting operations is applied to prevent the hardware design from using a divide. Thus, 64 different quantization values correspond to 64 data inputs, the maximum value of which requires 18 bits. The lookup table requires a memory having 64 words for depth capacity and 18 bits for width capacity for storage, thus excessive memory resources are utilized.

Thus, the invention provides a method and device for reducing memory resource utilization, conserving memory resources and enhancing system performance.

### BRIEF SUMMARY OF THE INVENTION

Methods for reducing memory resource utilization are provided. An exemplary embodiment of a method for reducing memory resource utilization applied to simplify address space of a table comprises the following. Values stored in address fields of an original table are analyzed to determine whether a logical relationship is detected between the values. If the logical relationship is detected, the values stored in the original table are classified to multiple base values and corresponding reduced values to generate a transformation table. Values comprising the same logical base value relationships and the corresponding reduced values are stored in a new and equivalent address field of a reduction table.

Devices for reducing memory resource utilization are provided. An exemplary embodiment of a device for reducing memory resource utilization applied to simplify address space of a table comprises a first storage medium, a second storage medium, a decoder, and a multiplexer. The first storage medium stores a transformation table generated by analyzing and classifying values stored in an original table. The second storage medium stores a reduction table generated by reducing multiple base values stored in the transformation table and reduced values corresponding to each base value. The decoder obtains a first address with, at most, an X bit input and decodes the first address to obtain a second address with, at most, a Y bit input, wherein X>Y. The multiplexer determines whether a logical operation is performed according to the first address, the transformation table, and the reduction table, if the logical operation is not performed, a decoding value corresponding to the second address is output directly, and, if the logical operation is performed, implements the logical operation to the decoding value corresponding to the second address.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a schematic view of contents of DQScale[Qc];

FIG. 2 is a schematic view of simplified contents of DQScale[Qc] derived from FIG. 1 according to defined rules;

FIG. 3 is a schematic view of an embodiment of a device for reducing memory resource utilization during video or audio processes;

FIG. 4 is a schematic view of predefined conversion rules for converting 64-bit address decoding to 32-bit address decoding;

FIG. 5 is a flowchart of an embodiment of a method for reducing memory resource utilization, applied to simplifying the address space of a table; and

FIG. 6 is a flowchart of an embodiment of a method for reducing memory resource utilization, applied to calculating actual and valid addresses.

### DETAILED DESCRIPTION OF THE INVENTION

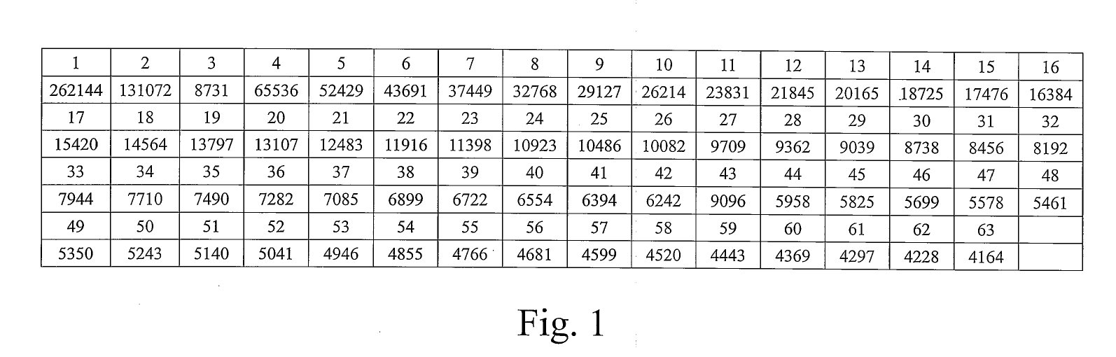

Several exemplary embodiments of the invention are described with reference to FIGS. 1 through 3, which generally relate to conserving memory resources. It is to be understood that the following disclosure provides various different embodiments as examples for implementing different features of the invention. Specific examples of components and arrangements are described in the following to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various described embodiments and/or configurations.

The invention discloses a method and device for reducing memory resource utilization during video or audio processes. A lookup table is reduced to a table requiring 32 words for depth capacity and 15 bits for width capacity by performing shift and addition (subtraction) operations and by use of a multiplexer. It is noted that an embodiment of a method and device for reducing memory resource utilization can also be applied to processing audio signals, but is not intended to be limitative. In the following only a video signal processing using the method and device is described as an example.

With respect to Microsoft Video Codec 1 (VC-1), quantization, coefficient scaling, direct coefficient/alternating coefficient (DC/AC) prediction, and motion vector prediction employ great memory resources. Thus, an embodiment of a method and device for reducing memory resource utilization reduces contents of a lookup table by performing shift and addition (subtraction) operations and by use of a multiplexer, thus conserving memory resources.

When DC/AC prediction and compensation are implemented, if current block and predicted block with different quantization parameters, coefficient adjustment is implemented on the image blocks to be predicted and compensated. Coefficient adjustment for VC-1 is implemented using equation 1, represented as:

$${\tilde{C}}_{p} = ( {C}_{p} \times \frac{{Q}_{p}}{{Q}_{c}} \times 262144 + 0 x 20000 ) >> 18 , \qquad ( Eq . 1 )$$

where Cₚ represents coefficient values of the image blocks to be predicted and compensated and Qₚ and Q_{c} represent quantization values of the image blocks to be predicted and compensated and that to be currently processed respectively. Further, equation 1 is simplified to obtain equation 2, represented as:

$${\tilde{C}}_{p} = ( {C}_{pi} \times \frac{262144}{{Q}_{c}} + 0 x 20000 ) >> 18 , \qquad ( Eq . 2 )$$

where Cₚᵢ=Cₚ×Q_{P} represent resulting values generated by dequantizing the image blocks to be predicted and Q_{c} is located within 1˜64. Hardware designs can employ a lookup table to reduce the excessively large hardware area and resources consumed by operations requiring a divider, such that a function DQScale[Qc] is substituted for

$$\frac{262144}{{Q}_{c}}$$

of equation 2 to generate equation 2, represented as:

\tilde{C}ₚ=(Cₚᵢ×DQScale[Qc]+0x20000)>>18 (Eq. 3),

Where the value of DQScale[Qc] is obtained according to the lookup table, in which the resulting value

$$\frac{262144}{{Q}_{c}}$$

of is obtained according to Q_{c}.

The table shown in FIG. 1 illustrates contents of DQScale[Qc]. Referring to FIG. 1, 262144 is the maximum value. The table requires a memory having 64 words for depth capacity and 18 bits for width capacity. Further, the 2-th power relationship among different values for different groups is shown in the table. Thus, a portion of values in the table can only be reserved and the remaining values therein are derived from the reserved values using shift and compensation operations, such that the originally stored 64 values are reduced to 32 values.

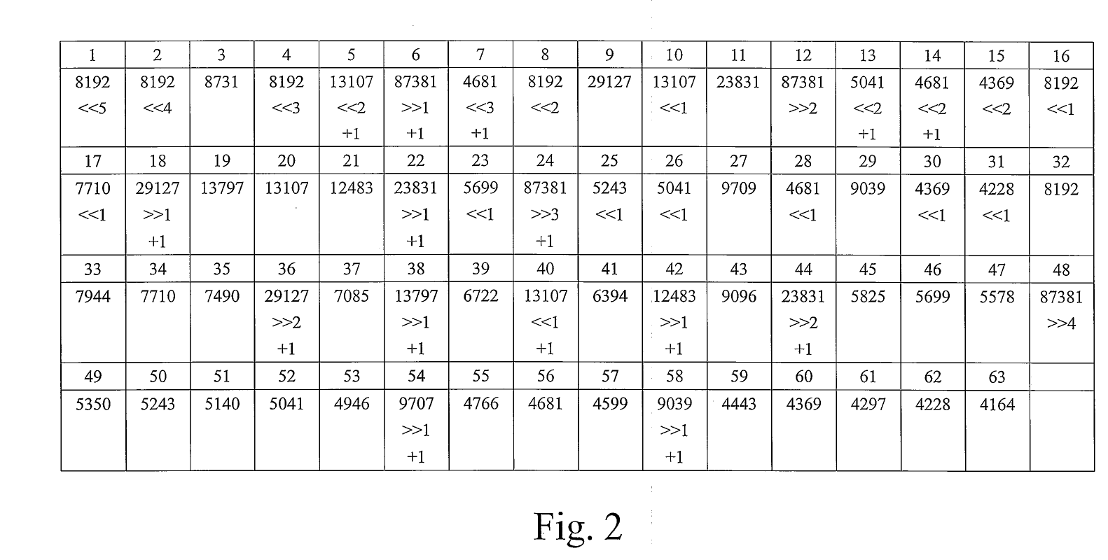

The reduction of the table is implemented using two, but is not limited to, two rules. The first rule takes smaller values as base values to reduce the width capacity of an applied memory. Further, while the process of deriving other values from base values is performed, if subtraction compensation and shift operations are both used, preventing a subtraction is the top priority. Thus, FIG. 2 is derived from FIG. 1 according to the two rules.

Referring to the table shown in FIG. 2, each bold number is a base value corresponding to other related values and can be used to generate 1 to 5 values. Referring to the tables shown in FIGS. 1 and 2, for example, the decoding value of the field with the address 32 is “8192” and the decoding value of the field with the address 1 is “8192×2⁵=262144”, represented as “23831<<5”. Further, the decoding value of the field with the address 11 is “23831” and the decoding value of the field with the address 22 is “23831÷2+1=11916”, represented as “23831>>1+1”. As described, the reduced table only requires memory capacity of 32 words. To prevent subtraction, each base value is not the minimum value, thus, 15˜17 bits (determined by whether an adder or a subtractor is used) for depth capacity of a memory are required.

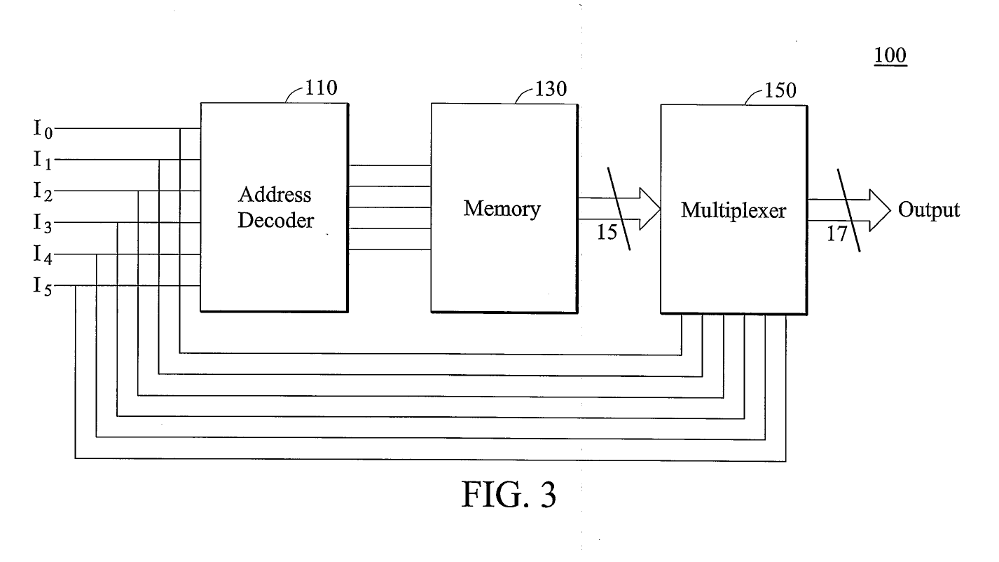

FIG. 3 is a schematic view of an embodiment of a device for reducing memory resource utilization during video or audio processes.

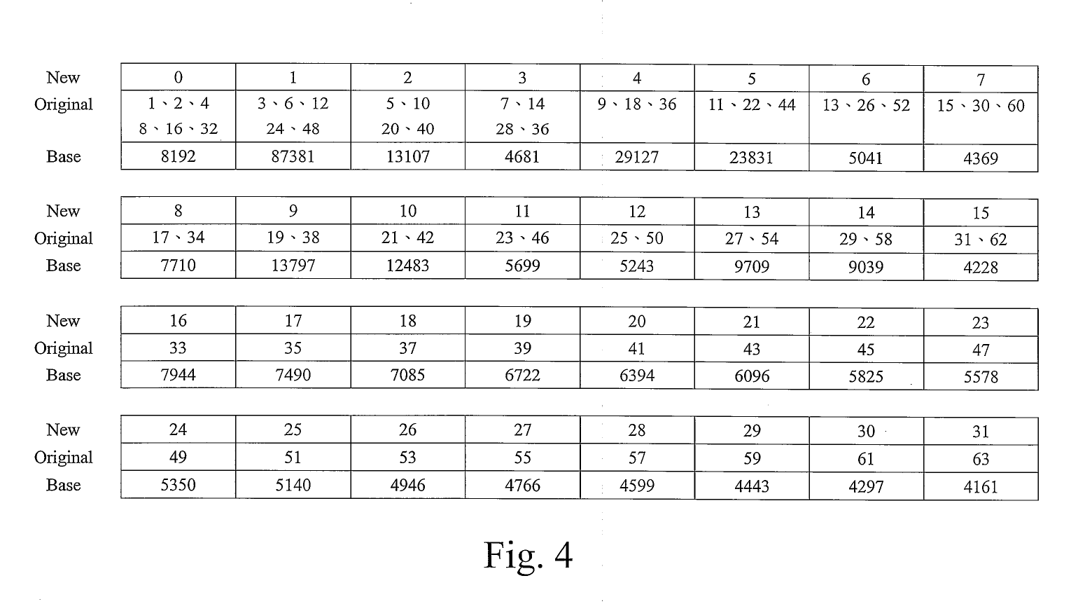

Device 100 comprises an address decoder 110, a memory 130 (a random access memory (RAM), for example), and a multiplexer 150. The input requires 6 bits (0˜63) when a lookup operation is performed but only 5 bits are required for the reduced memory. Thus, address decoder 110 first converts 64-bit address decoding to 32-bit address decoding (based on conversion rules shown in FIG. 4) and stores the reduced table in memory 130. The reduced table requires a memory having 32 words for depth capacity and 15 bits for width capacity. Applicable shift and addition (or subtraction) operations for compensation are determined and selected using multiplexer 150 according to output from memory 130 to obtain correct results. Additionally, the revised lookup table can obtain required output within a clock cycle.

Referring to the table shown in FIG. 4, the field with the new address 0 comprises decoding values with original addresses 1, 2, 4, 8, 16, and 32 and the base value referred to the original addresses is “8192”. Thus, when an output from memory 130 is “16384”, the output value is the decoding value of the field with the address 16 based on the table shown in FIG. 1. Referring to FIGS. 2 and 4, the decoding value should be stored in the field with the address 0 in the table shown in FIG. 4 after implementing shift compensation. Further, referring to the table shown in FIG. 4, the field with the new address 10 comprises decoding values with original addresses 21 and 42 and the base value referring to the original addresses is “12483”. Thus, when an output from memory 130 is “6242”, the output value is the decoding value of the field with the address 42 based on the table shown in FIG. 1. Referring to FIGS. 2 and 4, the decoding value should be stored in the field with the address 10 in the table shown in FIG. 4 after shift and addition (or subtraction) compensations are implemented (selecting the integer part).

It is noted that, with respect to the hardware design, address decoder 110 can be integrated with memory 130 and shift and addition (or subtraction) operations can be implemented using a shifter and an adder (or a subtractor). Additionally, an exclusive address decoder can be designed and installed in memory 130 to substitute for address decoder 110 to decode input addresses to actual and valid addresses.

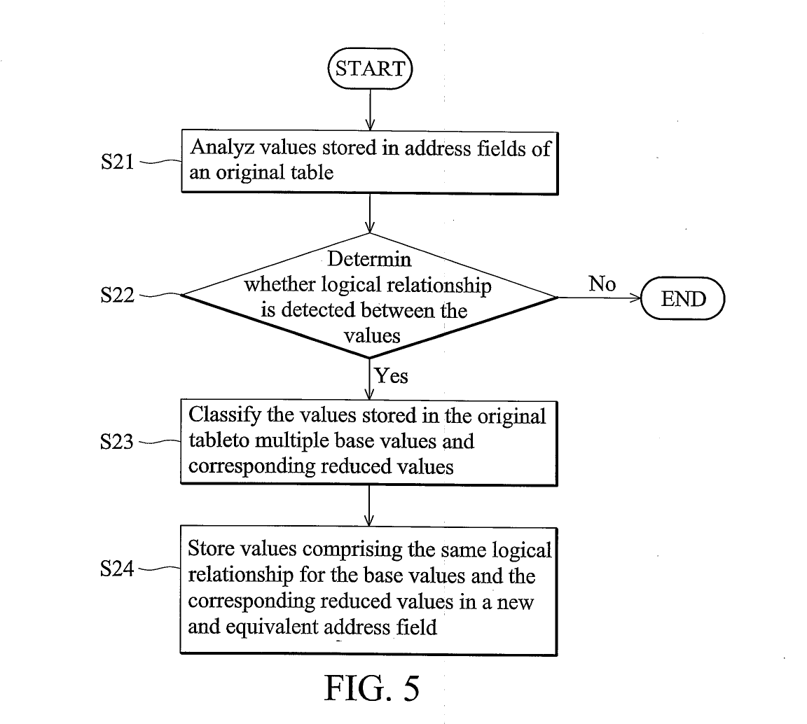

FIG. 5 is a flowchart of an embodiment of a method for reducing memory resource utilization, applied to simplify address space of a table.

Values stored in address fields of an original table are analyzed (step S21) to determine whether a logical relationship (the 2-th power relationship, for example) is detected between the values (step S22). If the logical relationship is not detected, the process terminates. If the logical relationship is detected, the values stored in the original table are classified to multiple base values and corresponding reduced values (step S23), thus reducing the memory space required for storing the values. A table originally requiring a memory having 64 words for depth capacity and 18 bits for width capacity requires, when reduced, a memory having 32 words for depth capacity and 17 bits, at most, for width capacity. Next, values comprising the same logical relationship for the base values and the corresponding reduced values are stored in a new and equivalent address field of a reduction table (step S24).

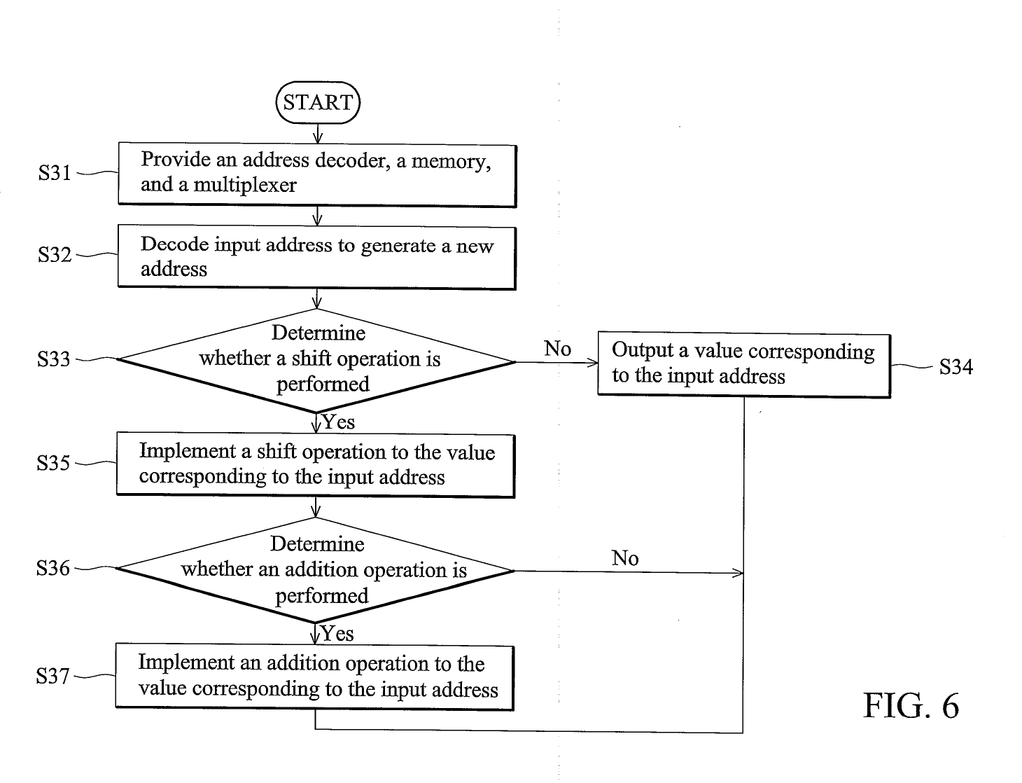

FIG. 6 is a flowchart of an embodiment of a method for reducing memory resource utilization, applied to calculation of actual and valid addresses.

An address decoder, a memory, and a multiplexer are first provided for a device (step S31). The memory has 32 words for depth capacity and 15 bits for width capacity and stores a reduction table, as the table shown in FIG. 4. Logical relationships (the 2-th power relationship, for example) are detected between portions of values of the reduction and an original (as the table in FIG. 1 shows). Additionally, a memory stores a transformation table corresponding to the reduction table, representing whether shift or addition (or subtraction) compensation is implemented on a value stored in a field of the reduction table. The address decoder obtains and decodes a 6-bit (at most) input address to generate a 5-bits (at most) input address corresponding to the reduction table (step S32).

Next, the multiplexer determines whether a shift operation is performed according to the originally input address, the transformation table, and the reduction table (step S33). If the shift operation is not performed, a value corresponding to the input address is directly output (step S34). If the compensation operation is performed, a shift operation is implemented on the value corresponding to the input address using the multiplexer (step S35). Next, the multiplexer determines whether an addition operation (or a subtraction operation) is performed according to the originally input address, the transformation table, and the reduction table (step S36). If the addition (or subtraction) operation is not performed, the value corresponding to the input address is directly output (step S34). If the addition (or subtraction) operation is performed, an addition operation (or a subtraction operation) is implemented on the value corresponding to the input address using the multiplexer (step S37), and the value corresponding to the input address is output.

A method and device for reducing memory resource utilization has been described using, but is not limited to, VC-1 technology, any video and audio compression technology using a multiplier or divider for hardware design can also utilize the method and device to reduce contents of a lookup table, reducing memory resource utilization.

Methods and systems of the invention, or certain aspects or portions of embodiments thereof, may take the form of program code (i.e., instructions) embodied in media, such as floppy diskettes, CD-ROMS, hard drives, firmware, or any other machine-readable storage medium, wherein, when the program code is loaded into and executed by a machine, such as a computer, the machine becomes an apparatus for practicing embodiments of the disclosure. The methods and apparatus of the invention may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing and embodiment of the disclosure. When implemented on a general-purpose processor, the program code combines with the processor to provide a unique apparatus that operates analogously to specific logic circuits.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for reducing memory resource utilization, applied to simplify address space of a table, comprising:
analyzing values stored in address fields of an original table to determine whether logical relationship is detected between the values;
if the logical relationship is detected, classifying the values stored in the original table to multiple base values and corresponding reduced values to generate a transformation table; and
storing values comprising the same logical relationship for the base values and the corresponding reduced values in a new and equivalent address field of a reduction table.

2. The method for reducing memory resource utilization as claimed in claim 1, wherein the logical relationship represents the N-th power relationship.

3. The method for reducing memory resource utilization as claimed in claim 1, further comprising converting the original table requiring A words for depth capacity and B bits for width capacity to the reduction table requiring C words for depth capacity and D bits at most for width capacity to store the base values and the corresponding reduced values, where A>C and B>D.

4. The method for reducing memory resource utilization as claimed in claim 1, further comprising:
obtaining a first address with X bit input at most;
decoding the first address to obtain a second address with, at most, a Y bit input, wherein X>Y;
determining whether a logical operation is performed according to the first address, the transformation table, and the reduction table;
if the logical operation is not performed, directly outputting a decoding value corresponding to the second address; and
if the logical operation is performed, implementing the logical operation to the decoding value corresponding to the second address.

5. The method for reducing memory resource utilization as claimed in claim 4, wherein the logical operation is a shift operation.

6. The method for reducing memory resource utilization as claimed in claim 4, further comprising:
determining whether a compensation operation is performed according to the first address, the transformation table, and the reduction table;
if the compensation operation is not performed, directly outputting the decoding value; and
if the compensation operation is performed, implementing an addition operation to the decoding value and outputting the added decoding value.

7. The method for reducing memory resource utilization as claimed in claim 6, wherein the compensation operation is an addition operation or a subtraction operation.

8. A device for reducing memory resource utilization, applied to simplify address space of a table, comprising:
a first storage medium, storing a transformation table generated by analyzing and classifying values stored in an original table;
a second storage medium, storing a reduction table generated by reducing multiple base values stored in the transformation table and reduced values corresponding to each base value;
a decoder, obtaining a first address with X bit input at most and decoding the first address to obtain a second address with, at most, a Y bit input, wherein X>Y; and
a multiplexer, coupled to the first storage medium, the second storage medium, and the decoder, determining whether a logical operation is performed according to the first address, the transformation table, and the reduction table, if the logical operation is not performed, directly outputting a decoding value corresponding to the second address, and, if the logical operation is performed, implementing the logical operation to the decoding value corresponding to the second address.

9. The device for reducing memory resource utilization as claimed in claim 8, wherein the logical operation is a shift operation.

10. The device for reducing memory resource utilization as claimed in claim 8, the multiplexer further determines whether a compensation operation is performed according to the first address, the transformation table, and the reduction table, if the compensation operation is not performed, directly outputs the decoding value, and, if the compensation operation is performed, implements an addition operation to the decoding value and outputs the added decoding value.

11. The device for reducing memory resource utilization as claimed in claim 10, wherein the compensation operation is an addition operation or a subtraction operation.

12. The device for reducing memory resource utilization as claimed in claim 8, wherein the decoder is installed in the multiplexer to decoded input addresses as actual and valid addresses.

13. A computer-readable storage medium storing a computer program providing a method for reducing memory resource utilization, comprising using a computer to perform the steps of:
analyzing values stored in address fields of an original table to determine whether logical relationship is detected between the values;
if the logical relationship is detected, classifying the values stored in the original table to multiple base values and corresponding reduced values to generate a transformation table; and
storing values comprising the same logical relationship for the base values and the corresponding reduced values in a new and equivalent address field of a reduction table.

14. The computer-readable storage medium as claimed in claim 13, wherein the logical relationship represents the N-th power relationship.

15. The computer-readable storage medium as claimed in claim 13, further comprising converting the original table requiring A words for depth capacity and B bits for width capacity to the reduction table requiring C words for depth capacity and D bits at most for width capacity to store the base values and the corresponding reduced values, where A>C and B>D.

16. The computer-readable storage medium as claimed in claim 13, further comprising:
obtaining a first address with X bit input at most;
decoding the first address to obtain a second address with, at most, a Y bit input, wherein X>Y;
determining whether a logical operation is performed according to the first address, the transformation table, and the reduction table;
if the logical operation is not performed, directly outputting a decoding value corresponding to the second address; and
if the logical operation is performed, implementing the logical operation to the decoding value corresponding to the second address.

17. The computer-readable storage medium as claimed in claim 16, wherein the logical operation is a shift operation.

18. The computer-readable storage medium as claimed in claim 16, further comprising:
determining whether a compensation operation is performed according to the first address, the transformation table, and the reduction table;
if the compensation operation is not performed, directly outputting the decoding value; and
if the compensation operation is performed, implementing an addition operation to the decoding value and outputting the added decoding value.

19. The computer-readable storage medium as claimed in claim 18, wherein the compensation operation is an addition operation or a subtraction operation.
